(19) United States
(12) Patent Application Publication
(10) Pub. No.: US 2025/0348446 A1
(43) Pub. Date: Nov. 13, 2025

(54) COMMUNICATION SYSTEM, COMMUNICATION METHOD, AND STORAGE MEDIUM STORING PROGRAM

(71) Applicant: DENSO CORPORATION, Kariya-city (JP)

(72) Inventors: Shota SUGIMOTO, Kariya-city (JP); Takehiro NAGATO, Kariya-city (JP); Takeshi IWANA, Kariya-city (JP)

(21) Appl. No.: 19/203,244

(22) Filed: May 9, 2025

(30) Foreign Application Priority Data
May 13, 2024 (JP) 2024-078083

(51) Int. Cl. G06F 13/16; H04L 67/01

(52) U.S. Cl. CPC G06F 13/1668; H04L 67/01

(57) ABSTRACT

A communication system, a communication method, or a non-transitory computer-readable storage medium storing a program is used for a control unit to transmit a communication signal including an address identifying at least one communication partner to the at least one communication partner, and stores a setting value for generating the communication signal or reads the setting value, and generates the communication signal according to the setting value stored in a memory. The setting value includes count values for defining a time period. The communication signal is generated by inverting a signal level each time the time period based on the count values elapses.

### CROSS REFERENCE TO RELATED APPLICATION

The present application claims the benefit of priority from Japanese Patent Application No. 2024-078083 filed on May 13, 2024. The entire disclosure of the above application is incorporated herein by reference.

### TECHNICAL FIELD

The present disclosure relates to a technology for a control unit to transmit, to at least one communication partner, a communication signal including an address identifying the communication partner.

### BACKGROUND

As a comparative example, a system includes a master device and a slave device. In the system of the comparative example, the master device transmits a command including the address of the slave device according to a point-to-point network protocol (for example, single edge nibble transmission (SENT) protocol). The slave device processes the received command and generates a response when the address included in the command matches the address of the slave device.

### SUMMARY

According to aspects of the present disclosure, a communication system, a communication method, or a non-transitory computer-readable storage medium storing a program is used for a control unit to transmit a communication signal including an address identifying at least one communication partner to the at least one communication partner, and stores a setting value for generating the communication signal or reads the setting value, and generates the communication signal according to the setting value stored in a memory. The setting value includes count values for defining a time period. The communication signal is generated by inverting a signal level each time the time period based on the count values elapses.

### BRIEF DESCRIPTION OF THE DRAWINGS

The above features of the present disclosure will become more apparent from the following detailed description made with reference to the accompanying drawings.

FIG. 1 is a diagram showing an example of the configuration of a communication system according to a first embodiment.

FIG. 2 is a flowchart showing a process for generating a communication signal including an address identifying a communication partner and for receiving data transmitted from the communication partner.

FIG. 3 is a flowchart showing details of a process in S110 in the flowchart of FIG. 2.

FIG. 4 is a diagram showing an example of setting values.

FIG. 5 is a diagram showing another example of the setting values.

FIG. 6 is a timing chart for describing an operation of an ECU when generating and outputting a communication signal according to the setting value.

FIG. 7 is a diagram showing communication signals generated by the setting values shown in FIG. 4.

FIG. 8 is a diagram showing communication signals generated by the setting values shown in FIG. 5.

FIG. 9 is a flowchart showing an example of a process for generating a communication signal according to a second embodiment.

FIG. 10 is a diagram showing an example of a configuration of a communication system according to a third embodiment.

### DETAILED DESCRIPTION

The system of the comparative example transmits a command from one master device to multiple slave devices over a single communication line, and each slave device determines whether the addresses included in the command match, and responds when they match. As described above, the system of the comparative example is primarily intended for slave devices. However, a specific method for generating commands (communication signals) to be output from a master device has not been known.

In the above-described system of the comparative example, the master device includes a controller having a communication node, and the slave device includes a sensor having a bidirectional node. It is considered that, when the system of the comparative example is applied to a different target, the number and types of sensors change. In this way, when the number or type of sensors changes, it may become necessary to change the address included in the command. It is desirable for the controller to be able to flexibly respond to such address changes.

One example of the present disclosure provides a communication system, a communication method, and a program capable of flexibly responding to changes in an address of a communication partner.

According to an example embodiment, a communication system is for a control unit to transmit a communication signal including an address identifying at least one communication partner to the at least one communication partner includes: a memory that is provided in the control unit and stores a setting value for generating the communication signal; and a generation unit that is provided in the control unit and configured to generate the communication signal according to the setting value stored in the memory. The setting value includes a plurality of count values for defining a time period, and the generation unit is configured to generate the communication signal by inverting a signal level each time the time period based on the plurality of count values elapses.

According to another example embodiment, a communication method for a control unit to transmit a communication signal including an address identifying at least one communication partner to the at least one communication partner includes: reading a setting value stored in a memory of the control unit for generating the communication signal; and causing a generation unit provided in the control unit to generate the communication signal according to the read setting value. The setting value includes a plurality of count values for defining a time period, and the generation unit is configured to generate the communication signal by inverting a signal level each time the time period based on the plurality of count values elapses.

Further, according to another example embodiment, a non-transitory computer-readable storage medium stores a program executed by at least one processor for a control unit to transmit a communication signal including an address identifying at least one communication partner to the at least one communication partner, the program causing the at least one processor to: read a setting value stored in a memory of the control unit for generating the communication signal; and generate the communication signal according to the read setting value. The setting value includes a plurality of count values for defining a time period, and the communication signal is generated by inverting the signal level each time the time period based on multiple count values elapses.

As described above, according to the communication system, communication method, and program of the present disclosure, the communication signal including the address identifying the communication partner is generated by reading the setting value stored in the memory and according to the read setting value. The setting value includes a number of count values for defining the time period. The communication signal is generated by inverting the signal level every time the time period based on multiple count values elapses.

Accordingly, for changing the address due to a change in the number or type of communication partners, it is only necessary to change the setting value stored in the memory. Therefore, it is possible to provide a communication system, a communication method, and a program capable of performing flexible operation for changes in the address of the communication partner.

Hereinafter, embodiments of a communication system, a communication method, and a program according to the present disclosure will be described with reference to the drawings. However, the present disclosure is not limited to the following embodiments, and various modifications described below are also included in the technical scope of the present disclosure. Furthermore, in addition to the following, various changes can be made within the range that does not deviate from the scope of the present disclosure. Embodiments and various modifications to be described below may be executed in combination as appropriate within a scope of the present disclosure that does not cause technical inconsistency. Note that, in the following descriptions, the same or similar components are denoted by the same reference symbols throughout multiple drawings, and description thereof may be omitted. Further, when only a part of the configuration is mentioned, the above description can be applied to the other parts.

### First Embodiment

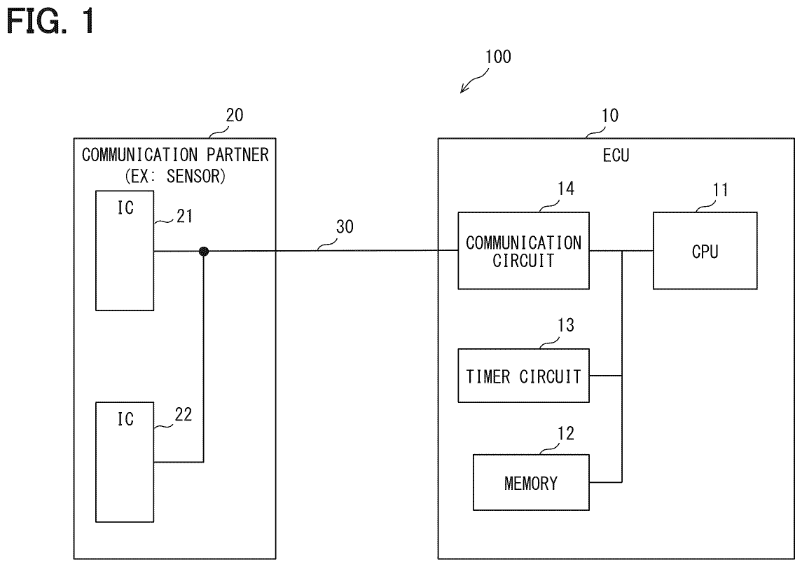

FIG. 1 is a diagram showing an example of a configuration of a communication system 100 according to the first embodiment. The communication system 100 includes an electronic control unit (ECU) 10 as a control unit, and at least one ICs 21 and 22 as a communication partner 20. The ECU 10 and the ICs 21 and 22 are connected to each other via a single communication line 30 so as to communicate with each other. The communication from the ICs 21 and 22 to the ECU 10 may be performed according to, for example, the SENT protocol. FIG. 1 shows an example in which two communication partners of ICs 21 and 22 are provided. The number of communication partners of the ICs 21 and 22 may be one, or three or more.

The SENT protocol is in principle a communication protocol for point-to-point systems. The SENT protocol uses pulse width modulation and transmits signals in 4-bit units called nibbles. More specifically, the SENT protocol starts from a falling edge, and after a low level for 5 ticks, the length of the high level corresponding to 12 to 27 ticks represents “0000” to “1111”. A tick refers to the basic unit of time in the SENT protocol. In the present embodiment, the communication protocol for communicating from the ICs 21 and 22 to the ECU 10 is not limited to the SENT protocol, and other communication protocols may be adopted.

In the present embodiment, as described in detail later, each of the ICs 21 and 22 that are the communication partner of the ECU 10 is assigned a unique address in advance. The ECU 10 is configured to transmit a communication signal including the address of the ICs 21 and 22 with which it is to communicate.

The ICs 21 and 22 as communication partners each have a signal processing circuit and a communication circuit. The signal processing circuit may be a computer including a CPU and a memory, or may be a dedicated processing circuit for processing digital signals. When each of the ICs 21 and 22 receives a communication signal from the ECU 10 through the communication circuit, the signal processing circuit determines whether the address included in the communication signal matches its own address. Then, only when the address contained in the communication signal matches its own address, the device executes the process according to instructions by the communication signal (for example, transmits sensor data).

Each of the ICs 21 and 22 may constitute, for example, a sensor device. When the ICs 21 and 22 constitute the sensor device, the ICs 21 and 22 are each connected to a detection element (not shown) that detects a predetermined physical quantity. Then, the ICs 21 and 22 generate sensor data in the signal processing circuits based on the detection signals from the corresponding detection elements. The sensor data generated by the ICs 21 and 22 may relate to the same type of physical quantity, or may relate to different types of physical quantities.

Furthermore, each of the ICs 21 and 22 can receive a communication signal from the ECU 10 through the communication circuit, and can also transmit a signal including sensor data from the communication circuit to the ECU 10. In the present embodiment, each of the ICs 21 and 22 is configured to transmit a signal including the generated sensor data to the ECU 10 in response to receiving a communication signal including an address that matches its own address from the ECU 10.

Here, in each of the ICs 21 and 22, there are several possible variations in the timing at which the sensor data is generated. For example, in a first example, each of the ICs 21 and 22 generates sensor data from the detection signal in response to receiving a communication signal including its own address from the ECU 10, and transmits the generated sensor data to the ECU 10. In a second example, each of the ICs 21 and 22 has a storage that temporarily stores the generated sensor data. Each of the ICs 21 and 22 periodically generates sensor data and stores the generated sensor data in the storage. Then, in response to receiving a communication signal including an address that matches its own address from the ECU 10, each of the ICs 21 and 22 transmits the sensor data stored in the storage. In a third example, in response to receiving a measurement trigger signal from the ECU 10, for example, intended for all the ICs 21 and 22, each of the ICs 21 and 22 generates sensor data from a detection signal and stores the sensor data in the storage. Then, in response to receiving a communication signal including an address that matches its own address from the ECU 10, each of the ICs 21 and 22 transmits the sensor data stored in the storage.

The sensor device constituted by each of the ICs 21 and 22 detects desired physical quantities required to control a control target, such as the position, angle, acceleration, vibration, pressure, flow rate, temperature, humidity, and magnetic flux of a detection target. The sensor device constituted by each of the ICs 21 and 22 can be used to control various mobile objects and mechanical equipment such as automobiles, motorcycles, trucks, aircraft, drones, robots, production equipment, and construction machinery. For example, automobiles are equipped with systems that require multiple sensor devices, such as an electric power steering system, a fuel injection control system, an air conditioning system, and various ADAS systems. The communication system 100 according to the present embodiment can be suitably applied to communication between the multiple sensor devices and a control unit of the corresponding system.

However, the communication partner with the ECU 10 in the communication system 100 according to the present embodiment is not limited to the ICs 21 and 22 that constitute the sensor device. For example, the communication system 100 according to the present embodiment may be applied to communication between ECUS.

The ECU 10 may be configured by a computer including at least one processor, a CPU 11, and a memory 12 that stores programs executed by the CPU 11, multiple setting values for generating communication signals including addresses of each of the ICs 21 and 22, and the like. The memory 12 includes a RAM, a ROM, a flash memory, and the like. The ECU 10 further includes a timer circuit 13 and a communication circuit 14.

Each setting value stored in the memory 12 includes a number of count values for defining a time period. The timer circuit 13 operates to count the multiple count values included in each setting value in sequence. The communication circuit 14, which serves as a generation unit, generates a communication signal including the addresses of each of the ICs 21 and 22 by inverting the signal level when the timer circuit 13 completes counting the count value of the count target, and transmits it out from the communication line 30. Furthermore, when the communication circuit 14 receives sensor data from each of the ICs 21 and 22, it outputs the received sensor data to the CPU 11.

As described above, the communication signal including the address of each of the ICs 21 and 22 may instruct the ICs 21 and 22 that has received the communication signal including the address matching its own address to transmit the sensor data. Additionally, the communication signal including the address of each of the ICs 21 and 22 may instruct the ICs 21 and 22 that receives the communication signal including the address matching its own address to generate the sensor data based on the detection signal. In addition, for example, when at least one of the ICs 21 and 22 is connected to multiple detection elements and can generate multiple sensor data, the communication signal including the address of each of the ICs 21 and 22 may instruct the ICs 21 and 22 capable of generating multiple sensor data to transmit sensor data while specifying the type of sensor data to be transmitted.

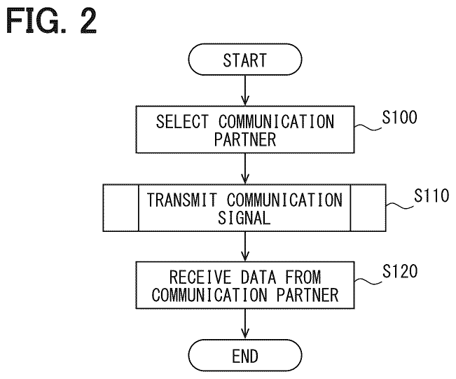

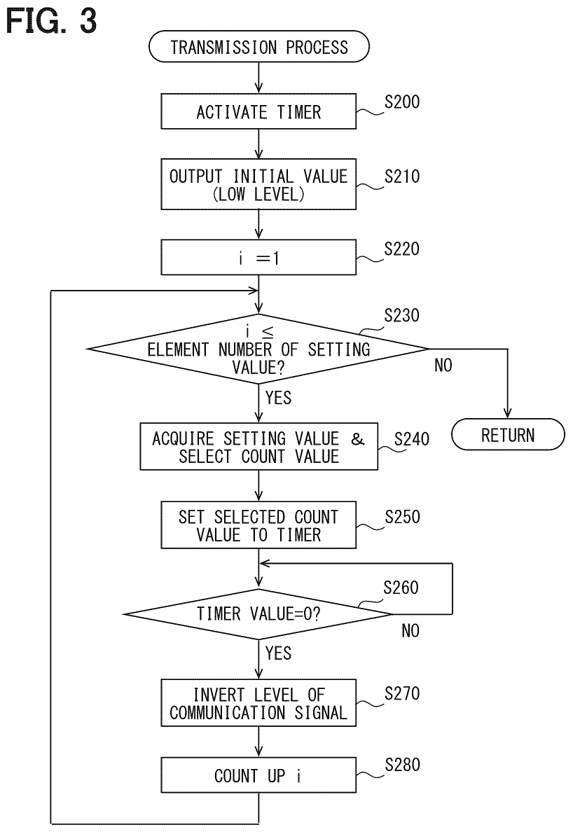

Next, an example of a process executed in the ECU 10 to generate the communication signal including an address identifying the communication partner will be described with reference to flowcharts of FIGS. 2 and 3. The processes shown in the flowcharts of FIGS. 2 and 3 can be implemented mainly by the CPU 11 of the ECU 10, and the CPU 11 of the ECU 10 executes a program stored in the memory 12. FIGS. 2 and 3 are repeatedly executed, for example, each time the ECU 10 determines that it is time to acquire the sensor data from each of the ICs 21 and 22.

In the first process of S100, the ECU 10 selects the ICs 21 and 22 that should be the communication partner in the current process. In the next S110, the ECU 10 executes a process of generating and transmitting the communication signal including the address of the selected communication partners ICs 21 and 22. When each of the ICs 21 and 22 receives the communication signal, the ICs 21 and 22 having an address that matches the address in the communication signal returns the sensor data to the ECU 10. In S120, the ECU 10 receives the sensor data transmitted from the ICs 21 and 22.

The flowchart in FIG. 3 shows details of the process of S110 in the flowchart in FIG. 2. In the first process of S200 in the flowchart of FIG. 3. the ECU 10 activates the timer circuit 13. Thereby, the timer circuit 13 is possible to perform a counting operation.

In S210, the ECU 10 outputs an initial value (for example, a low level signal) as a communication signal from the communication circuit 14. In S220, the ECU 10 sets a variable i to “1”. In S230, the ECU 10 compares the variable i with the number of elements of the setting value, that is, the number of count values included in the setting value. When the variable i is equal to or smaller than the number of elements of the setting value, the ECU 10 proceeds to a process of S240. On the other hand, when the variable i is greater than the number of elements of the setting value, the process shown in the flowchart of FIG. 3 ends. Immediately after the variable i is set to “1” in S220, the setting value includes multiple count values. Thus, in S230, it is determined that the variable i is equal to or less than the number of elements of the setting value.

In S240, the ECU 10 reads out from the memory 12 and acquires the setting values corresponding to the ICs 21 and 22 that are the communication partners selected in S100 of the flowchart in FIG. 2. Furthermore, the ECU 10 selects one count value from among the multiple count values included in the acquired setting value. The count value is selected according to the arrangement order (array order) of the count values. That is, in the first selection, the leading count value is selected from among the multiple count values. Then, each time the counting of the selected count value is completed, the next count value is selected according to the arrangement order of the count values.

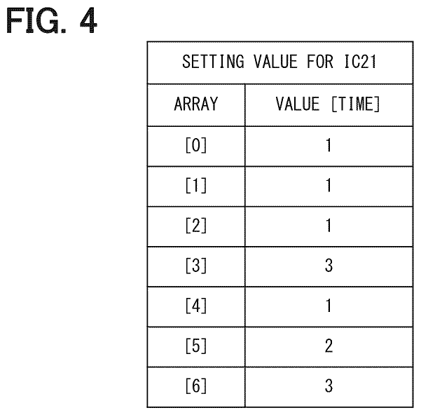

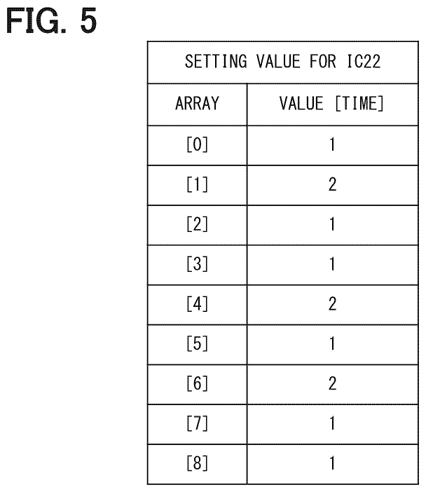

FIG. 4 shows an example of setting values for IC 21. In the example shown in FIG. 4, the setting values include seven count values. The seven count values are expressed in order as 1, 1, 1, 3, 1, 2 and 3. FIG. 5 also shows an example of setting values for IC 22. In the example shown in FIG. 5, the setting values include nine count values. The nine count values are expressed in order as 1, 2, 1, 1, 2, 1, 2, 1 and 1. The count values are selected according to their respective arrangement orders (array orders).

In S250 of the flowchart in FIG. 3, the ECU 10 sets the selected count value in the timer circuit 13. When the count value is set, the timer circuit 13 performs a countdown from the set count value as a counting operation every time a predetermined unit time elapses. Then, in S260, the ECU 10 determines whether the count value of the timer circuit 13 has reached zero. When it is determined that the count value has reached 0, the ECU 10 proceeds to the process of S270. On the other hand, when it is determined that the count value is not zero, the ECU 10 repeatedly executes the process of S260 until the count value becomes zero.

In S270, the ECU 10 inverts the level of the communication signal output from the communication circuit 14. For example, when the communication circuit 14 outputs a low level communication signal, the ECU 10 inverts the level of the communication signal to a high level. Conversely, when the communication circuit 14 outputs a high level communication signal, the ECU 10 inverts the level of the communication signal to a low level.

In S280, the ECU 10 counts up the variable i. Thereafter, the process proceeds to S230. Then, in S230, the variable i after the count-up process is compared with the number of elements of the setting value. When the variable i is equal to or smaller than the number of elements of the setting value, the process proceeds to S240. Accordingly, the processes of S240 to S280 are repeated a number of times corresponding to the number of elements of the setting value.

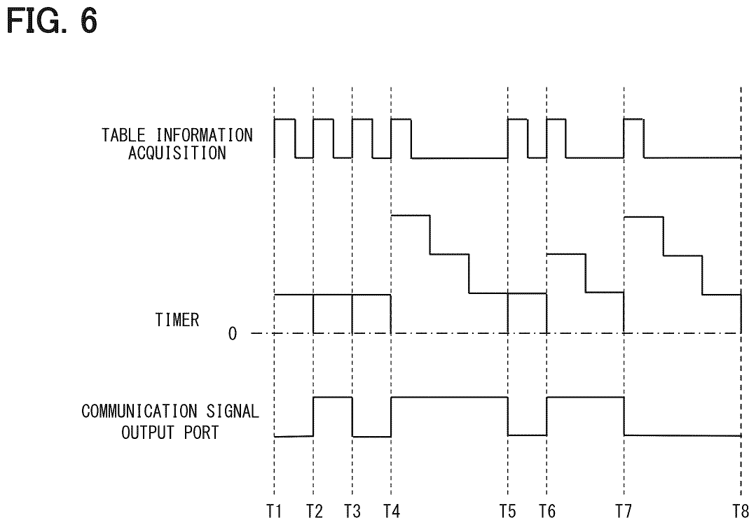

Here, the operation of the ECU 10 when generating and outputting a communication signal according to the setting value will be described in detail with reference to the timing chart of FIG. 6. The timing chart of FIG. 6 shows the operation of the ECU 10 generating and outputting a communication signal according to the setting values for the IC 21.

In FIG. 6, at time T1, the timer circuit 13 is activated and, at the same time, a low level signal, for example, is output from the output port of the communication circuit 14 as the initial value of the communication signal. Furthermore, at the time T1, the first count value “1” among the multiple count values (1, 1, 1, 3, 1, 2, 3) included in the setting value is set in the timer circuit 13.

At time T2, when a predetermined unit time has elapsed since time T1 and the count value of the timer circuit 13 becomes “0”, the level of the communication signal is inverted and the level of the communication signal output from the output port of the communication circuit 14 changes to a high level. Furthermore, at time T2, the next (second) count value “1” is set in the timer circuit 13 according to the arrangement (array order) of the multiple count values.

At time T3, when a predetermined unit time has elapsed since the time T2 and the count value of the timer circuit 13 becomes “0”, the level of the communication signal is inverted and the level of the communication signal output from the output port of the communication circuit 14 changes to a low level. Furthermore, at the time T3, the next (third) count value “1” is set in the timer circuit 13 according to the arrangement (order) of the multiple count values.

At time T4, when a predetermined unit time has elapsed since the time T3 and the count value of the timer circuit 13 becomes “0”, the level of the communication signal is inverted and the level of the communication signal output from the output port of the communication circuit 14 changes to a high level. Furthermore, at time T4, the next (fourth) count value “3” is set in the timer circuit 13 according to the arrangement (order) of the multiple count values.

At time T5, when the time has elapsed since time T4 in which the timer circuit 13 counts down from the count value “3” to the count value “0”, the level of the communication signal is inverted. The level of the communication signal output from the output port of the communication circuit 14 changes to a low level. Furthermore, at time T5, the next (fifth) count value “1” is set in the timer circuit 13 according to the arrangement (array order) of the multiple count values.

Similar operations are also performed at times T6 and T7, and when the count value of the timer circuit 13 becomes “0”, the level of the communication signal is inverted and a new count value is set in the timer circuit 13 according to the arrangement order (array order) of the multiple count values. Then, at time T8, the value of variable i becomes “8”, so that the value of variable i becomes greater than the number of elements of the setting value. Therefore, at the time T8, the level of the communication signal is not inverted and a new count value is not set in the timer circuit 13.

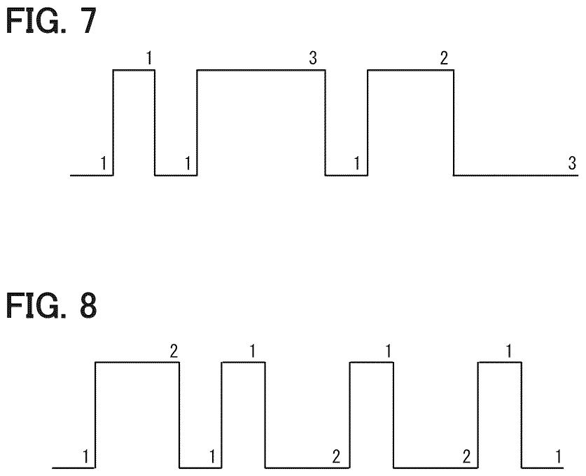

By the above-described operation of the ECU 10, a communication signal corresponding to the multiple count values included in the setting value is generated and transmitted from the communication line 30. FIG. 7 shows the communication signals generated by the setting values for IC 21 shown in FIG. 4. FIG. 8 also shows the communication signals generated by the setting values for IC 22 shown in FIG. 5.

Thus, according to the present embodiment, the communication signal including the address that identifies the communication partner is generated according to the setting values stored in the memory 12. The setting value includes a number of count values for defining the time period. The communication signal is generated by inverting the signal level every time a time based on multiple count values elapses. Therefore, even in a case where the number or type of communication partners changes, when it becomes necessary to change the address, it is only necessary to change the setting value stored in the memory 12. Therefore, according to the present embodiment, it becomes possible to flexibly respond to changes in the address of the communication partner.

In the above-described first embodiment, the multiple count values included in the setting value are set in the timer circuit 13 according to the arrangement order of the multiple count values. The timer circuit 13 has been described as an example in which the timer circuit 13 counts down from the set counter value every time a predetermined unit time elapses. However, the counting of the count value by the timer circuit 13 is not limited to this example. That is, multiple count values included in the setting value may be set as threshold values to be compared with the count value of the timer circuit 13 according to the order of the multiple count values. In this case, the timer circuit 13 may be initialized to 0 according to the set threshold value and to count up from the initial value each time a predetermined unit time elapses.

### Second Embodiment

Next, a second embodiment of the present disclosure will be described with reference to the drawings.

In the above-described first embodiment, the timer circuit 13 is used to count multiple count values included in the setting value. However, in the second embodiment, the timer circuit 13 is not used, and instead, the RAM included in the memory 12 of the ECU 10 is utilized to count the multiple count values included in the setting values. Accordingly, in the present embodiment, the ECU 10 has a configuration in which the timer circuit 13 is omitted from the configuration shown in FIG. 1.

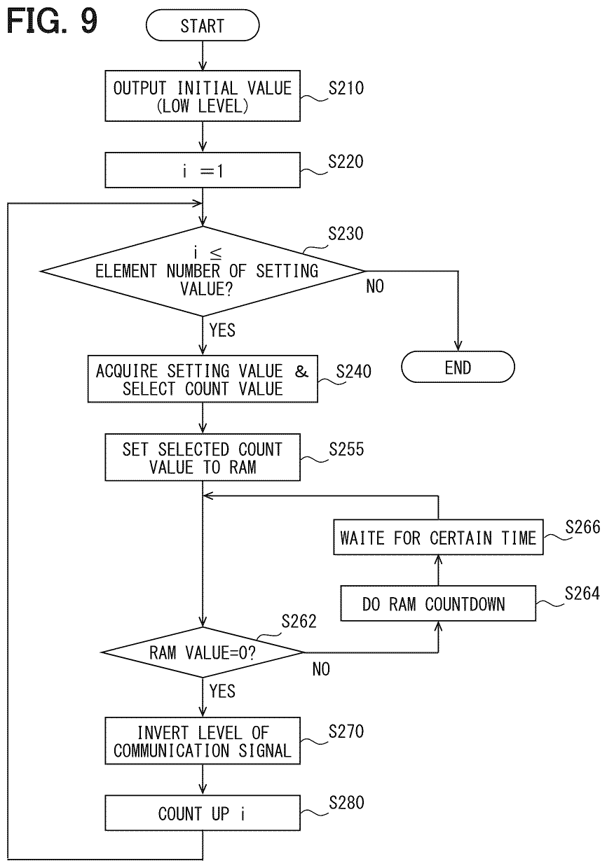

FIG. 9 is a flowchart showing an example of a process for generating a communication signal by counting a count value using the RAM included in the memory 12 according to the second embodiment. Note that some processes in the flowchart of FIG. 9 execute the same processes as the corresponding processes in the flowchart of FIG. 9. In this way, similar processes are given the same reference numbers, and descriptions thereof may be omitted.

As shown in the flowchart of FIG. 9, in the present embodiment, the timer circuit 13 is not used, so a process of starting the timer circuit 13 is not provided. Furthermore, processes in S210 to S240 and S270 to S280 in the flowchart of FIG. 9 are similar to the processes corresponding to those in the flowchart of FIG. 3.

In S255, the ECU 10 sets the selected count value in a predetermined area of the RAM. In S262, the ECU 10 determines whether the RAM value has become zero. When it is determined that the RAM value has become 0, the ECU 10 proceeds to the process of S270. On the other hand, when it is determined that the RAM value is not 0, the ECU 10 proceeds to the process of S264.

In S264, the ECU 10 executes the countdown of the RAM value. Then, in S266, the ECU 10 waits until a certain time equivalent to a predetermined unit time has elapsed. Thereafter, the ECU 10 proceeds to the process in S262. By such a process, the ECU 10 can count the multiple count values included in the setting value without using the timer circuit 13. As a result, the ECU 10 can generate a communication signal according to the multiple count values included in the setting value.

In the present embodiment as well, the count value may be set as a threshold value, and the RAM value may be counted up from an initial value of 0.

### Third Embodiment

Next, a third embodiment of the present disclosure will be described with reference to the drawings.

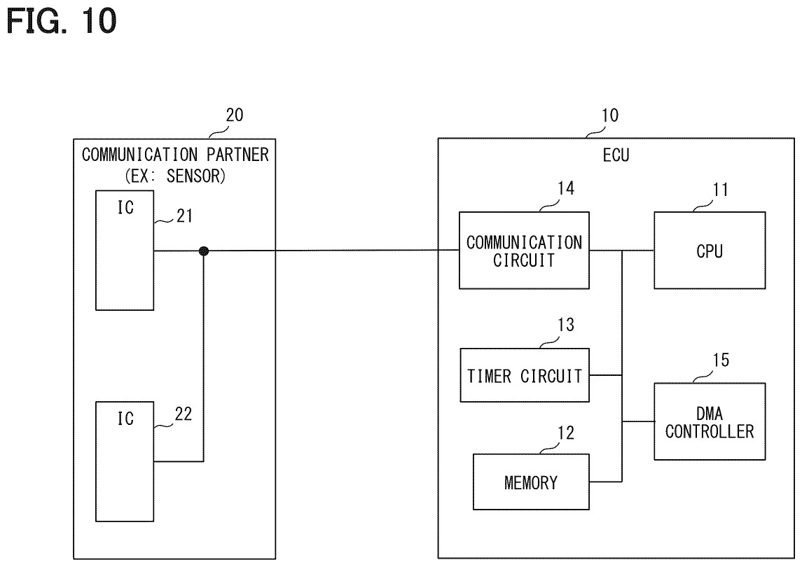

In the above-described first embodiment, an example has been described in which the CPU 11 of the ECU 10 reads out a setting value stored in the memory 12 and sets multiple count values included in the read setting value in the timer circuit 13. In contrast, in the third embodiment, as shown in FIG. 10, a direct memory access (DMA) controller 15 is configured to read multiple count values included in the setting values stored in the memory 12 and set the read count values in the timer circuit 13. Hereinafter, the operation of the ECU 10 shown in FIG. 10 will be described.

Each time the CPU 11 determines that the time has come to acquire sensor data from each of the ICs 21 and 22, it specifies, for the DMA controller 15, the address where the multiple count values are stored and the number of count values to be transferred, which are included in the setting values for generating the communication signal including the address of the ICs 21 and 22 that are to be the communication partner. Furthermore, the CPU 11 instructs the DMA controller 15 to start transferring the count value to the timer circuit 13.

In response to a transfer start instruction from the CPU 11, the DMA controller 15 reads the count value from the specified address of the memory 12 and transfers it to the timer circuit 13. Then, the DMA controller 15 is triggered by the completion of counting the count value set in the timer circuit 13, and reads out the next count value and sets it in the timer circuit 13. The DMA controller 15 repeats this process a number of times equal to the count value instructed by the CPU 11.

As in the present embodiment, the transfer of the count value from the memory 12 to the timer circuit 13 is performed by the DMA controller 15, it is possible to reduce the processing load on the CPU 11. Furthermore, since the count value can be set in the timer circuit 13 at high speed by the DMA controller 15, it becomes possible to always generate a communication signal with an appropriate shape.

In the above-described third embodiment, the CPU 11 and the DMA controller 15 can be considered to function as the processor of the present disclosure.

The flowcharts shown in the present disclosure are examples, and the number of processes constituting the flowcharts and the execution order of the processes can be changed as appropriate. The system and the method described in the present disclosure may be implemented by a dedicated computer which includes a processor programmed to execute one or more functions executed by computer programs. The system and the method described in the present disclosure may be also implemented by a dedicated hardware logic circuit. Further, the system and the method described in the present disclosure may be also implemented by one or more dedicated computers which are constituted by combinations of a processor for executing computer programs and one or more hardware logic circuits. For example, some or all of the functions of the ECU 10 may be implemented as hardware. An aspect in which a certain function is implemented as hardware includes an aspect in which the function is implemented by use of one or more ICs or the like. As the processor, a CPU, an MPU, a GPU, a DFP (Data Flow Processor), or the like can be adopted. Some or all of the functions of ECU 10 may be implemented using any of a system-on-chip (SoC), an integrated circuit (IC), and a field-programmable gate array (FPGA). The concept of IC also includes ASIC (Application Specific Integrated Circuit). Further, the computer program may be stored in a computer-readable non-transitionary tangible storage medium as an instruction executed by the computer. As a program storage medium, an HDD (Hard-disk Drive), an SSD (Solid State Drive), a flash memory, or the like can be adopted. The scope of the present disclosure also includes programs for causing a computer to function as the ECU 10, a non-transitory tangible storage medium such as semiconductor memory which stores the programs, and other aspects.

What is claimed is:

1. A communication system for a control unit to transmit a communication signal including an address identifying at least one communication partner to the at least one communication partner, the system comprising:
a memory that is provided in the control unit and stores a setting value for generating the communication signal; and
a generation unit that is provided in the control unit and configured to generate the communication signal according to the setting value stored in the memory,
wherein
the setting value includes a plurality of count values for defining a time period, and
the generation unit is configured to generate the communication signal by inverting a signal level each time the time period based on the plurality of count values elapses.

2. The communication system according to claim 1, further comprising
a timer circuit configured to operate to count the plurality of count values in sequence,
wherein
the generation unit is configured to generate the communication signal by inverting the signal level in response to completion of counting, among the plurality of count values, a count value that is a count target of the timer circuit.

3. The communication system according to claim 2, further comprising
a direct memory access controller configured to sequentially read the plurality of count values included in the setting value from the memory, and set the count value in the timer circuit.

4. The communication system according to claim 1, wherein
in the control unit, the plurality of count values are counted in sequence by a repetitive process that is repeatedly executed at a constant control cycle, and
by the repetitive process, the generation unit is configured to generate the communication signal by inverting the signal level in response to completion of counting, among the plurality of count values, a count value that is a count target.

5. The communication system according to claim 1, wherein
the at least one communication partner includes a plurality of communication partners,
the control unit is configured to transmit, to the plurality of communication partners, the communication signal including the address identifying the communication partner,
the memory stores a plurality of setting values corresponding to the plurality of communication partners, and
the generation unit is configured to select, among the plurality of setting values, a setting value corresponding to, among the plurality of communication partners, a communication partner with which communication is performed.

6. The communication system according to claim 1, wherein
the at least one communication partner is a sensor device configured to detect a predetermined physical quantity, and
the control unit is used to acquire a sensor signal from the sensor device identified by the address included in the communication signal.

7. The communication system according to claim 1, wherein
the communication system is applied to communication between the control unit of an electric power steering system in a vehicle and a plurality of sensor devices.

8. A communication method for a control unit to transmit a communication signal including an address identifying at least one communication partner to the at least one communication partner, the method comprising:
reading a setting value stored in a memory of the control unit for generating the communication signal; and
causing a generation unit provided in the control unit to generate the communication signal according to the read setting value,
wherein
the setting value includes a plurality of count values for defining a time period, and
the generation unit is configured to generate the communication signal by inverting a signal level each time the time period based on the plurality of count values elapses.

9. A non-transitory computer-readable storage medium storing a program executed by at least one processor for a control unit to transmit a communication signal including an address identifying at least one communication partner to the at least one communication partner, the program causing the at least one processor to:
read a setting value stored in a memory of the control unit for generating the communication signal; and
generate the communication signal according to the read setting value,
wherein
the setting value includes a plurality of count values for defining a time period, and
the communication signal is generated by inverting a signal level each time the time period based on the plurality of count values elapses.
